(19) United States
(12) Patent Application Publication
(10) Pub. No.: US 2006/0245635 A1
(43) Pub. Date: Nov. 2, 2006

(54) Appearance inspection apparatus and appearance inspection method

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 11/405,984

(22) Filed: Apr. 17, 2006

(30) Foreign Application Priority Data
Apr. 27, 2005 (JP) 2005-129849

(51) Int. Cl. G06K 9/00

(52) U.S. Cl. 382/149

(57) ABSTRACT

The appearance inspection apparatus comprises: imaging unit which captures an image of the surface of a substrate; pixel comparing unit which compares pixels between images captured of a plurality of substrates, the pixels being located in corresponding positions in the captured images of the substrates; and defect detecting unit which detects one or other of the pixels associated with the plurality of substrates as a defect when the pixel associated with one of the substrates differs in pixel value from the pixel associated with the other one of the substrates.

### BACKGROUND OF THE INVENTION

1. Field of the Invention

The present invention relates to an appearance inspection apparatus and an appearance inspection method for detecting a defect appearing on a surface of a substrate on which a pattern is formed and, more particularly, to an appearance inspection apparatus and an appearance inspection method for detecting a defect on a substrate such as a liquid crystal display panel or in a semiconductor circuit pattern formed on a substrate such as a semiconductor wafer during a semiconductor fabrication process.

2. Description of the Related Art

It is widely practiced to generate image data by capturing an image of a formed pattern and to inspect the pattern for a defect, etc. by analyzing the image data. In particular, in the field of semiconductor fabrication, photomask inspection equipment for inspecting photomasks and appearance inspection equipment for inspecting patterns formed on semiconductor wafers or liquid crystal display panels are widely used. While the description in this specification is given by taking as an example an appearance inspection apparatus (inspection machine) for detecting a defect in a semiconductor circuit pattern formed on a semiconductor wafer during a semiconductor fabrication process, it will be recognized that the invention is not limited to this particular type of apparatus.

Generally, a bright field inspection apparatus, which illuminates the surface of a sample from a vertical direction and captures the image of its reflected light, is employed for this type of appearance inspection apparatus, but a dark field inspection apparatus, which does not directly capture the illumination light, is also used. In the case of the dark field inspection apparatus, the surface of the sample is illuminated from an oblique or a vertical direction, a sensor is disposed so as not to detect any specularly reflected light, and the dark field image of the surface of the sample is obtained by sequentially scanning the surface with the illumination light. Accordingly, certain types of dark field apparatus may not use image sensors, but it will be appreciated that the present invention is also applicable to such types of the apparatus. In this way, the present invention can be applied to any type of appearance inspection apparatus and appearance inspection method, provided that the apparatus and method are designed to inspect the appearance of a substrate based on the image captured of the surface of the substrate, such as a semiconductor wafer and a liquid crystal display panel, on which a pattern is formed.

FIG. 1 is a block diagram showing a prior art appearance inspection apparatus which is essentially the same as the appearance inspection apparatus that the applicant of this patent application proposed in Japanese Unexamined Patent Publication No. 2004-177397. As shown, a sample holder (chuck stage) 22 is mounted on the upper surface of a stage 21 which is movable in two- or three-dimensional directions. A semiconductor wafer 23 as a substrate to be inspected is placed on the sample holder 22 and held fixed thereon. An imaging device 24 constructed from a one-dimensional or two-dimensional CCD camera or the like is disposed above the stage, and the imaging device 24 generates an image signal by capturing an image of the pattern formed on the semiconductor wafer 23.

As shown in FIG. 2, a plurality of dies 23a are formed on the semiconductor wafer 23 in a matrix pattern repeating in X and Y directions. As the same pattern is formed on each die, it is general practice to compare the images of corresponding portions between adjacent dies. If there is no defect in the two adjacent dies, the gray level difference between them is smaller than a threshold value, but if there is a defect in either one of the dies, the gray level difference is larger than the threshold value (single detection). At this stage, however, this is no knowing which die contains the defect; therefore, the die is further compared with a die adjacent on a different side and, if the gray level difference in the same portion is larger than the threshold value, then it is determined that the die under inspection contains the defect (double detection).

The imaging device 24 comprises a one-dimensional CCD camera, and the stage 21 is moved so that the imaging device 24 moves (scans) relative to the semiconductor wafer 23 at a constant speed in the X or Y direction. The image signal is converted into a multi-valued digital signal (gray level signal), which is then supplied to a difference detection unit 26 and also to a signal storage unit 25 for storing therein. As the scanning proceeds, a gray level signal is generated from the adjacent die, in synchronism with which the gray level signal of the preceding die is read out of the signal storage unit 25 and supplied to the difference detection unit 26. Actually, processing such as fine registration is also performed, but a detailed description of such processing will not be given here.

The gray level signals of the two adjacent dies are input to the difference detection unit 26, which computes the difference (gray level difference) between the two gray level signals and supplies it to a detection threshold value calculation unit 27 and a defect detection unit 28. Here, the difference detection unit 26 computes the absolute value of the gray level difference and outputs it as the gray level difference. The detection threshold value calculation unit 27 determines the detection threshold value based on the gray level difference, and supplies the detection threshold value to the defect detection unit 28. The defect detection unit 28 compares the gray level difference with the thus determined threshold value to determine whether the portion under inspection is a defect or not.

Generally, the noise level of an image captured from a semiconductor pattern differs depending on the kind of the pattern, for example, whether it is a memory cell portion, a logic circuit portion, a wiring portion, or an analog circuit portion. Correspondence between each of such portions and the kind of the semiconductor pattern can be found from design data. Therefore, the detection threshold value calculation unit 27 automatically determines the threshold value for each portion, for example, in accordance with the distribution of the gray level difference in that portion, and the defect detection unit 28 makes the determination by using the threshold value determined for each portion.

### SUMMARY OF THE INVENTION

In the prior art appearance inspection apparatus, it has been practiced, as described above, to compare corresponding portions between adjacent dies (or cells) in the repeating patterns of the plurality of dies formed on the substrate or of the plurality of cells formed within each die and to detect any portion differing between them as a defect; alternatively, it has been practiced to create an exemplary reference image from design data or from past sample images and to detect any portion differing from the reference image as a defect.

However, with the method of comparing the corresponding portions of the repeating patterns, it is not possible to inspect the peripheral area of the wafer where the repeating patterns are not formed. Conventionally, the peripheral area has not been inspected because dies are not formed in this area; however, in this area, films formed in various semiconductor fabrication steps can easily delaminate from the substrate, producing particles which can lead to defects. Accordingly, detecting a defect in the peripheral area of the substrate and identifying the source of particles is very useful for the management of the semiconductor fabrication process.

On the other hand, the method of matching against the reference image requires that the reference image be created in accordance with each substrate to be inspected and each process step involved. Generally, when creating such a reference image from design data, it is extremely difficult to create a reference image that can compare with an actually captured image; on the other hand, when creating the reference image from past sample images, creating it for each substrate and each process step is cumbersome because, each time, the exemplary image must be synthesized from a large number of captured images.

In view of the above problems, it is an object of the present invention to provide an appearance inspection apparatus and an appearance inspection method that can detect defects not only in repeating pattern areas but also in other areas without having to create a reference image.

To achieve the above object, according to the present invention, when detecting a defect appearing on a surface of a substrate on which a pattern is formed or is to be formed, pixels located in corresponding positions in the captured images of a plurality of substrates are compared between the plurality of substrates, and one or other of the pixels associated with the plurality of substrates is detected as a defect when the pixel associated with one of the substrates differs in pixel value from the pixel associated with the other one of the substrates.

When a repeating pattern is formed as the pattern on the surface of the substrate, any defect appearing in an area on the surface of the substrate, other than an area thereof where the repeating pattern is formed, is detected. At the same time, any defect appearing in the repeating pattern area may also be detected.

To identify the substrate that contains the detected defect, the comparison between the pixels located in corresponding positions in the captured images of the substrates are made for the plurality of substrates, and a determination as to which of the substrates contains the defect is made by majority rule based on the results of the comparison.

Alternatively, the substrate that contains the detected defect may be identified in the following manner; that is, for each of the pixel values of the pixels located in corresponding positions in the captured images of the plurality of substrates, a deviation from an average value of the pixel values is obtained, and the substrate for which the deviation is larger than a predetermined threshold value is determined as the substrate that contains the defect.

In a further alternative method of identifying the substrate that contains the detected defect, when the pixel values of the pixels located in corresponding positions in the captured images of the plurality of substrates differ from each other, pixel value variation between each of the pixels and a pixel adjacent thereto is detected and, between the substrates, the substrate for which the detected variation is the larger is determined as the substrate that contains the defect.

### BRIEF DESCRIPTION OF THE DRAWINGS

The present invention will be more clearly understood from the description as set below with reference to the accompanying drawings, wherein:

FIG. 1 is a block diagram showing the general configuration of an appearance inspection apparatus according to the prior art;

FIG. 2 is a diagram showing an arrangement of dies on a semiconductor wafer;

FIG. 3 is a general perspective view of a semiconductor pattern appearance inspection apparatus according to an embodiment of the present invention;

FIG. 4 is a basic construction diagram (top plan view) showing the interior of a transport unit;

FIG. 5A is a basic construction diagram (side elevational view in cross section) showing the interior of the transport unit;

FIG. 5B is a perspective view of a wafer cassette;

FIG. 6 is a block diagram of a pre-inspection unit shown in FIG. 3;

FIG. 7 is a flowchart showing a first example of an appearance inspection method according to the present invention;

FIG. 8A is a diagram (part 1) for explaining the appearance inspection method according to the present invention shown in FIG. 7;

FIG. 8B is a diagram (part 2) for explaining the appearance inspection method according to the present invention shown in FIG. 7;

FIG. 9 is a diagram (part 3) for explaining the appearance inspection method according to the present invention shown in FIG. 7;

FIG. 10 is a flowchart showing a second example of the appearance inspection method according to the present invention; and

FIG. 11 is a flowchart showing a third example of the appearance inspection method according to the present invention.

### DESCRIPTION OF THE PREFERRED EMBODIMENTS

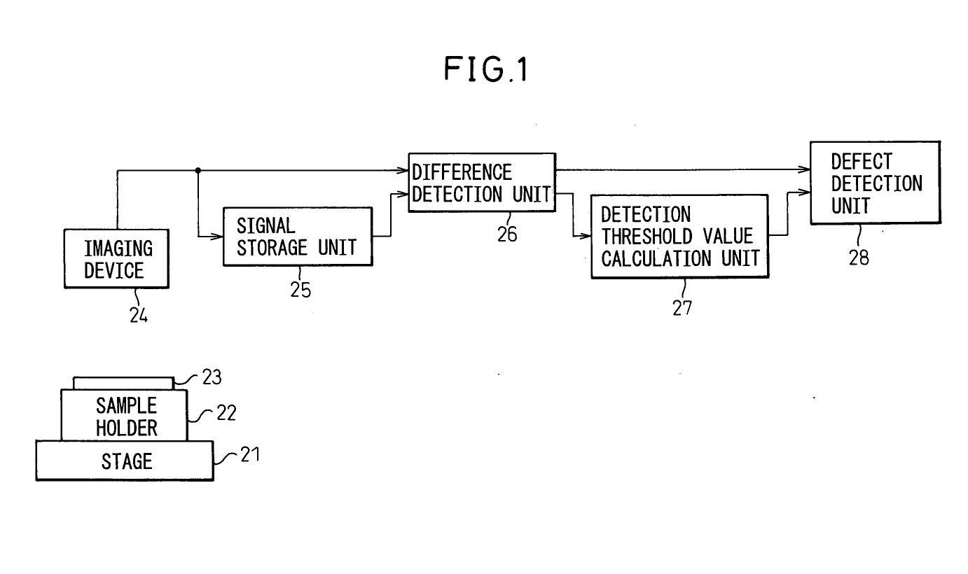

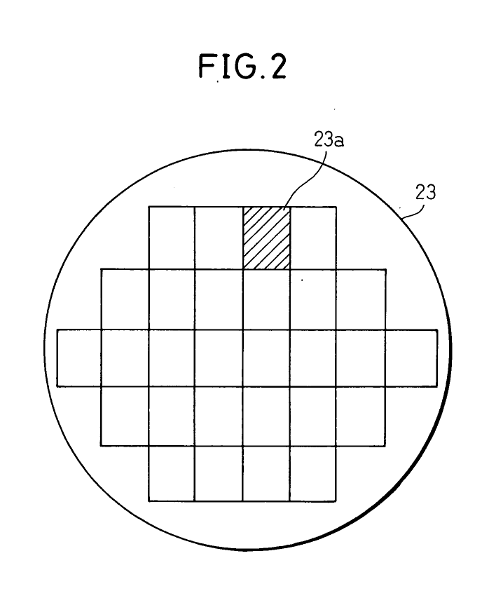

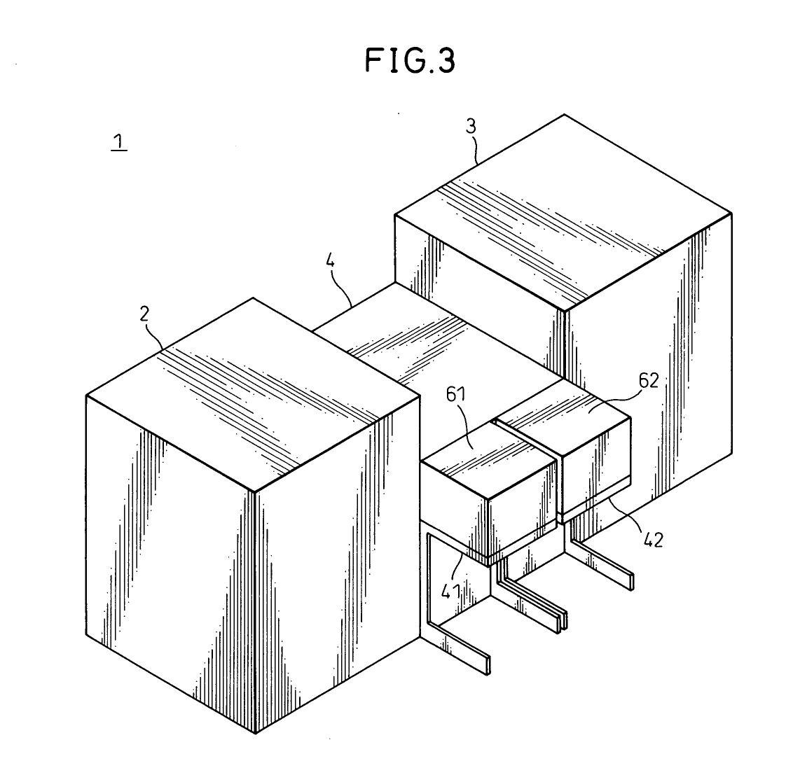

Preferred embodiments of the present invention will be described in detail below while referring to the attached figures. FIG. 3 is a general perspective view of a semiconductor pattern appearance inspection apparatus according to an embodiment of the present invention. The appearance inspection apparatus 1 includes an appearance inspection unit 2 as an appearance inspection means which is similar in configuration to the prior art appearance inspection apparatus described with reference to FIGS. 1 and 2. The appearance inspection unit 2 perform appearance inspection, such as the previously described die-to-die comparison and/or cell-to-cell comparison according to the prior art, on each of a plurality of wafers 23 (substrates) contained in wafer cassettes 61 and 62 mounted in the appearance inspection apparatus 1.

Also, the appearance inspection apparatus 1 includes a pre-inspection unit 3 as an appearance inspection apparatus according to the present invention. While the appearance inspection unit 2 is performing the appearance inspection of the prior art on one wafer contained in either one of the wafer cassettes 61 and 62, the pre-inspection unit 3 performs appearance inspection in accordance with an appearance inspection method of the present invention on other wafers contained in the wafer cassettes 61 and 62.

In the description of the embodiment hereinafter given, the appearance inspection apparatus according to the present invention is configured as the pre-inspection unit 3 which is provided as an attachment to the appearance inspection apparatus of the prior art, but the appearance inspection apparatus according to the present invention may be configured as a stand-alone apparatus.

Further, while a description is given by taking the semiconductor wafer 23 as an example of the substrate to be inspected by the appearance inspection apparatus and appearance inspection method according to the present invention, it is to be understood that various other substrates, such as substrates for liquid crystal devices used in liquid crystal panels, can also be inspected as long as they are substrates on which patterns are formed. The substrate to be inspected may be a wafer or a substrate for a liquid crystal device on which a pattern is already formed, or a wafer (bare wafer) or a substrate for a liquid crystal device on which such a pattern has yet to be formed. Furthermore, the appearance inspection apparatus and appearance inspection method according to the present invention can be used not only to inspect the surface of the substrate on which a pattern is formed, but also to inspect the opposite surface thereof.

The appearance inspection apparatus 1 further comprises: a transport unit 4 for selecting individual ones of the plurality of wafers contained in the wafer cassettes 61 and 26, and transporting them to the appearance inspection unit 2 and the pre-inspection unit 3; and cassette racks 41 and 42 as sample mounting units according to the present invention for mounting the wafer cassettes 61 and 62 thereon and setting them in the appearance inspection apparatus 1.

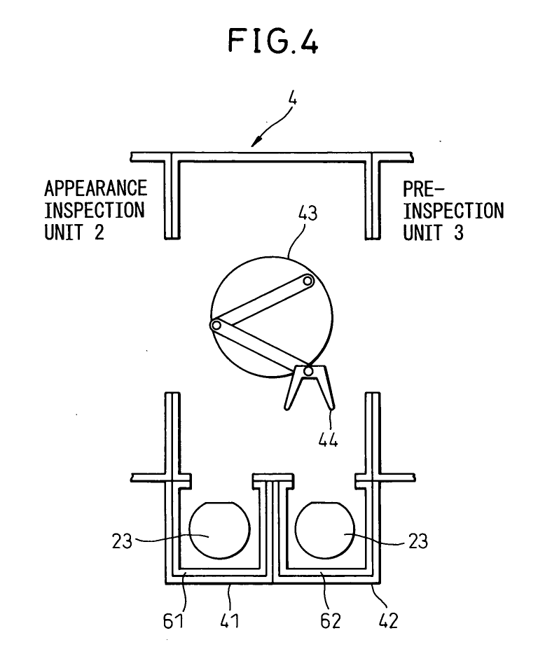

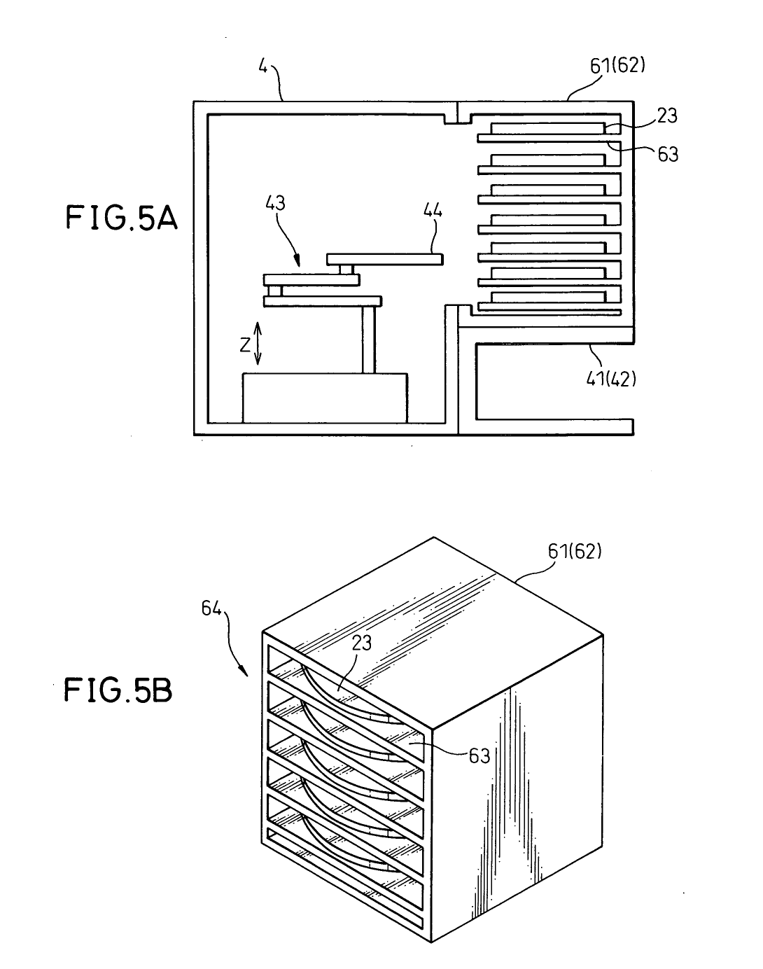

FIG. 4 is a basic construction diagram (top plan view) showing the interior of the transport unit 4, FIG. 5A is a basic construction diagram (side elevational view in cross section) showing the interior of the transport unit, and FIG. 5B is a perspective view of the wafer cassette.

As shown in FIGS. 4 and 5A, there is provided, inside the transport unit 4, an arm mechanism 43 for selecting one of the plurality of wafers 23 contained in the wafer cassettes 61 and 62 respectively mounted on the cassette racks 41 and 42, and for transporting it to the appearance inspection unit 2 or the pre-inspection unit 3, whichever is designated.

On the other hand, as shown in FIGS. 5A and 5B, the wafer cassettes 61 and 62 are each provided with a plurality of shelves 63 for holding the plurality of wafers 23, and are constructed so that each cassette can accommodate a predetermined number of wafers 23 (for example, 25 wafers) per lot with one wafer placed on each shelf and one above another.

The arm mechanism 43 shown in FIG. 4 is provided with a sample holder 44 and, as shown in FIG. 5B, with the arm mechanism 43 moving up and down in the Z direction in the plane of the figure, the sample holder 44 can pull out a desired wafer 23 selected from among the wafers 23 stacked within the wafer cassettes 61 and 62 and can place the wafer 23 onto the desired shelf in the wafer cassette 61 or 62.

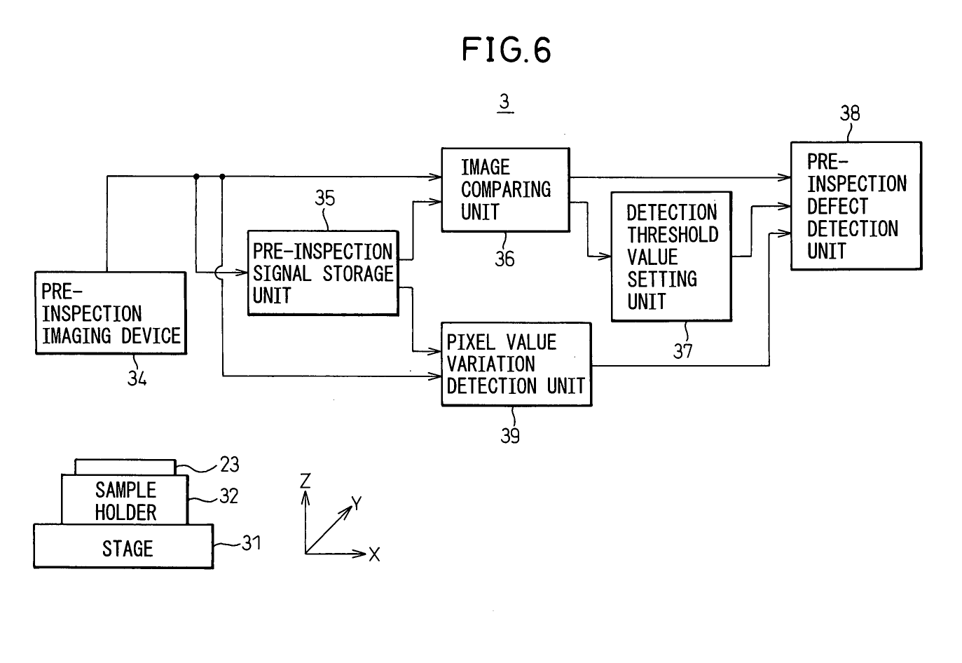

FIG. 6 is a block diagram of the pre-inspection unit 3 shown in FIG. 3. As shown, the pre-inspection unit 3 includes a sample holder (chuck stage) 32 mounted on the upper surface of a stage 31 which is movable in two or three directions. The semiconductor wafer 23 to be inspected is placed on the sample holder and held fixed thereon. A pre-inspection imaging device 34 is disposed above the stage, and the pre-inspection imaging device 34 generates an image signal by capturing an image of the pattern formed on the surface of the semiconductor wafer 23. Here, the pre-inspection imaging device 34 may generate the image signal by capturing the image of the entire surface area of the wafer 23 including the peripheral area thereof outside the die area where repeating patterns are formed or, when inspecting only the peripheral area outside the die area, it may generate the image signal representing only the captured image of the peripheral area.

The pre-inspection unit 3 further includes: a pre-inspection signal storage unit 35 which stores images acquired by capturing the images of the surfaces of a plurality of wafers 23 with the pre-inspection imaging device 34; a pixel comparing unit 36 which compares pixels located in corresponding positions in the captured images of the plurality of wafers 23 stored in the pre-inspection signal storage unit 35 (that is, those pixels in the images taken from the respectively corresponding positions on the plurality of wafers 23); a detection threshold value setting unit 37 for setting a detection threshold; and a pre-inspection defect detection unit 38 which detects a defect when it is determined, as a result of the comparison made by the pixel comparing unit 36 between one wafer and another wafer selected for comparison from the plurality of wafers 23, that the difference between the pixel values of the pixels in the corresponding positions in the captured images is larger than the detection threshold value.

Here, of the captured images of the plurality of wafers 23 to be compared, the pixel comparing unit 36 may be configured to read the captured image of the last wafer 23 directly from the pre-inspection imaging device 34, eliminating the need to store the captured image of that last wafer 23 in the pre-inspection signal storage unit 35; this serves to reduce the storage capacity requirements of the pre-inspection signal storage unit 35.

Further, the detection threshold value setting unit 37 may be configured to adaptively set the detection threshold value automatically in accordance with the captured image output from the pre-inspection imaging device 34 (for example, in accordance with the noise level of the captured image) or, alternatively, a predetermined fixed threshold value may be used. Further, the same detection threshold value may be used for all the points (pixels) in the captured image, or different detection threshold values may be set for different points (pixels) in the captured image, or the detection threshold value may be set for each area of predetermined size (for example, for each block of 10×10 pixels in the captured image).

The above component elements 36 to 39 can each be implemented as a program module to be executed on hardware having one or a plurality of data processing units. These program modules 36 to 39 may be stored in a storage device on which the data processing units can read and write data, and may be loaded as needed into the data processing unit, or units, and executed to serve the functions described above or to be described in detail below. Alternatively, the above component elements 36 to 39 may be configured as separate hardware circuits offering the respective functions.

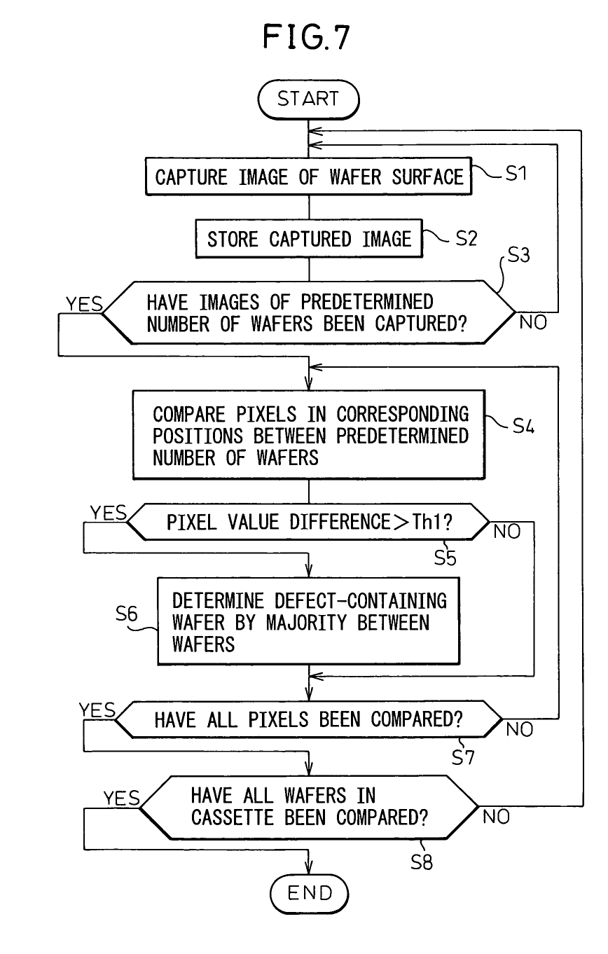

FIG. 7 is a flowchart showing a first example of the appearance inspection method according to the present invention.

First, in step S1, the arm mechanism 43 shown in FIG. 4 withdraws one of the plurality of wafers 23 from the wafer cassette 61 (or 62) and places it onto the sample holder 32 in the pre-inspection unit 3 shown in FIG. 6. Then, the pre-inspection imaging device 34 acquires a gray level signal by capturing an image of the surface of the wafer 23 placed on the sample holder 32.

Then, in step S2, the captured image thus acquired is stored in the pre-inspection signal storage unit 35. The above steps S1 and S2 are repeated until the images of the surfaces of a predetermined number of wafers 23 are acquired, and the captured images of the predetermined number of wafers 23 are stored in the pre-inspection signal storage unit 35 (S3).

In step S4, from the predetermined number of wafers 23 whose images are stored in the pre-inspection signal storage unit 35, the pixel comparing unit 36 selects pairs of wafers 23 so that one wafer can be compared with at least two other wafers, and compares pixels in corresponding positions in the captured images. Then, the difference between their pixel values is output to the pre-inspection defect detection unit 38.

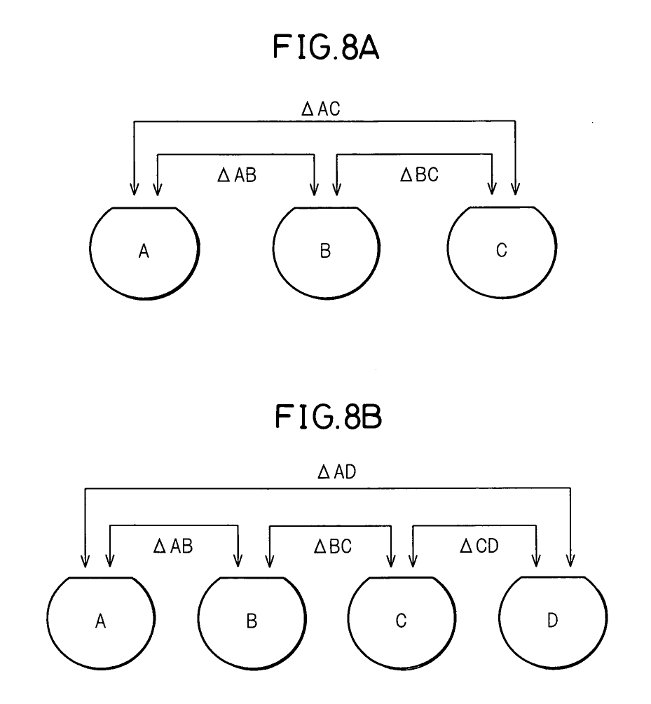

For example, when making comparisons between three wafers A, B, and C, as shown in FIG. 8A, the pixel comparing unit 36 compares pixels located in corresponding positions first between the pair of wafers A and B and then between the pair of wafers B and C in the order in which their images were captured, and then compares pixels located in corresponding positions between the first wafer A and the last wafer C.

Further, when making comparisons between four wafers A, B, C, and D, for example, as shown in FIG. 8B, the pixel comparing unit 36 compares pixels located in corresponding positions first between the pair of wafers A and B, then between the pair of wafers B and C, and then between the pair of wafers C and D in the order in which their images were captured, and then compares pixels located in corresponding positions between the first wafer A and the last wafer D.

In step S5, the pre-inspection defect detection unit 38 checks each pixel value difference input thereto to determine whether it is larger than the detection threshold value Th1 set by the detection threshold value setting unit 37; if the pixel value difference is larger than the detection threshold value Th1, then it is determined that there is a defect, and the process proceeds to step S6. If the pixel value difference is not larger than the detection threshold value Th1, it is determined that there is no defect, and the process proceeds to step S7.

In step S6, based on the pixel value differences input thereto, the pre-inspection defect detection unit 38 determines which of the plurality of wafers compared by the pixel comparing unit 36 contains the detected defect, by majority rule, based on the comparison results. In the example of FIG. 8A, when the pixel value differences are designated ΔAB, ΔBC, and ΔAC for the pair of wafers A and B, the pair of wafers B and C, and the pair of wafers A and C, respectively, if ΔAB>Th1, ΔBC≦Th1, and ΔAC>Th1, for example, then since the difference between the wafers B and C is small, the pixels associated with these wafers are judged to be normal and defect-free, and the pixel associated with the other wafer A is judged to be a defect.

Further, in the example FIG. 8B, when the pixel value differences are designated ΔAB, ΔBC, ΔCD, and ΔAD for the pair of wafers A and B, the pair of wafers B and C, the pair of wafers C and D, and the pair of wafers A and D, respectively, if ΔAB>Th1, ΔBC≦Th1, ΔCD≦Th1, and ΔAC>Th1, for example, then since the differences between the wafers B, C, and D are small, the pixels associated with these wafers are judged to be normal and defect-free, and the pixel associated with the other wafer A is judged to be a defect. When five or more wafers are compared in step S4, a majority decision similar to that described above can be employed.

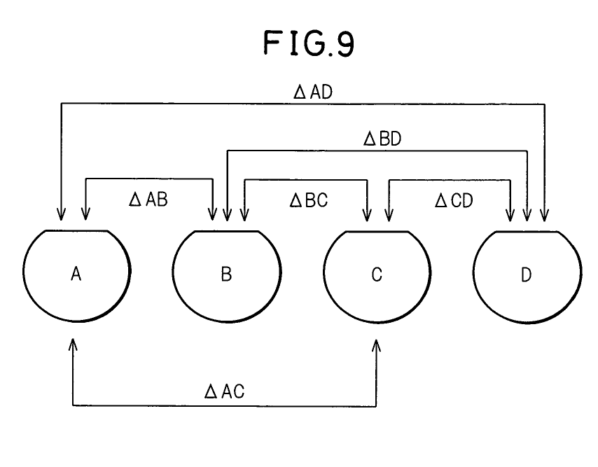

Further, in step S4, the pixel comparing unit 36 may compare pixels located in corresponding positions for every pair of wafers 23 that can be selected from the predetermined number of wafers 23 whose images are stored in the pre-inspection signal storage unit 35. For example, as shown in FIG. 9, when making comparisons between four wafers A, B, C, and D, the pixel comparing unit 36 may compare pixels located in corresponding positions between every pair of wafers 23 that can be selected from the four wafers A, B, C, and D, i.e., the pair of wafers A and B, the pair of wafers A and C, the pair of wafers A and D, the pair of wafers B and C, the pair of wafers B and D, and the pair of wafers C and D.

Then, in step S6, when the pixel value differences are designated ΔAB, ΔAC, ΔAD, ΔBC, ΔBD, and ΔCD for the pair of wafers A and B, the pair of wafers A and C, the pair of wafers A and D, the pair of wafers B and C, the pair of wafers B and D, and the pair of wafers C and D, respectively, if ΔAB>Th1, ΔAC>Th1, ΔAD>Th1, ΔBC≦Th1, ΔBD≦Th1, and ΔCD≦Th1, for example, then since the differences between the wafers B, C, and D are small, the pixels associated with these wafers are judged to be normal and defect-free, and the pixel associated with the other wafer A is judged to be a defect.

The above steps S4 to S6 are repeated for all the pixels contained in the captured images of the predetermined number of wafers 23 (S7), thus inspecting the entire surfaces of the wafers 23 for defects.

Then, the above steps S1 to S7 are repeated until the images of all the wafers 23 contained in the cassette 61 (or 62) are captured at least once and compared in step S4 by the pixel comparing unit 36 (S8).

Preferably, the pre-inspection unit 3 of FIG. 6 is operated to perform the above inspection on the wafers 23 contained in either one of the wafer cassettes 61 and 62 while the appearance inspection unit 2 of FIG. 3 is performing inspection on the wafers 23 contained in the other cassette. By constructing the appearance inspection apparatus 1 in this way, it becomes possible to prevent the throughput from being reduced due to the appearance inspection performed by the pre-inspection unit 3.

Further, the appearance inspection by the appearance inspection unit 2 is not always performed on all the wafers contained in the wafer cassette 61 (62), but may be performed by sampling some of the wafers 23. Therefore, it is preferable that the inspection time that the pre-inspection unit 3 requires to complete the appearance inspection of one cassette be set to about the same as or shorter than the inspection time that the appearance inspection unit 2 requires to perform the conventional appearance inspection on the prescribed number of wafers 23 sampled for inspection.

For this purpose, an imaging device having a lower resolution (fewer pixels) than the imaging device used as the imaging device 23 of FIG. 1, for example, may be used as the imaging device 34, thereby reducing the signal processing time and thus shortening the time required for the pre-inspection.

Alternatively, the time required for the pre-inspection may be reduced by employing a two-dimensional CCD as the imaging device 34 and thereby reducing the number of image capturing operations required to capture the images covering the entire surface of each wafer 23 and thus reducing the number of times that the stage 51 has to be moved during the image capturing.

On the other hand, a plurality of captured images covering the entire surface of each wafer 23 must be stored in the pre-inspection signal storage unit 35. Therefore, to reduce the storage capacity requirements of the pre-inspection signal storage unit 35, an imaging device having a lower resolution (fewer pixels) than the imaging device used as the imaging device 23 of FIG. 1, for example, may be used as the imaging device 34, as earlier described.

Further, of the captured images of the plurality of wafers 23 to be compared, the captured image of the last wafer 23 may not be stored in the pre-inspection signal storage unit 35, but may be loaded directly from the pre-inspection imaging device 34 into the pixel comparing unit 36 and used for comparison. This serves to reduce the storage capacity requirements of the pre-inspection signal storage unit 35.

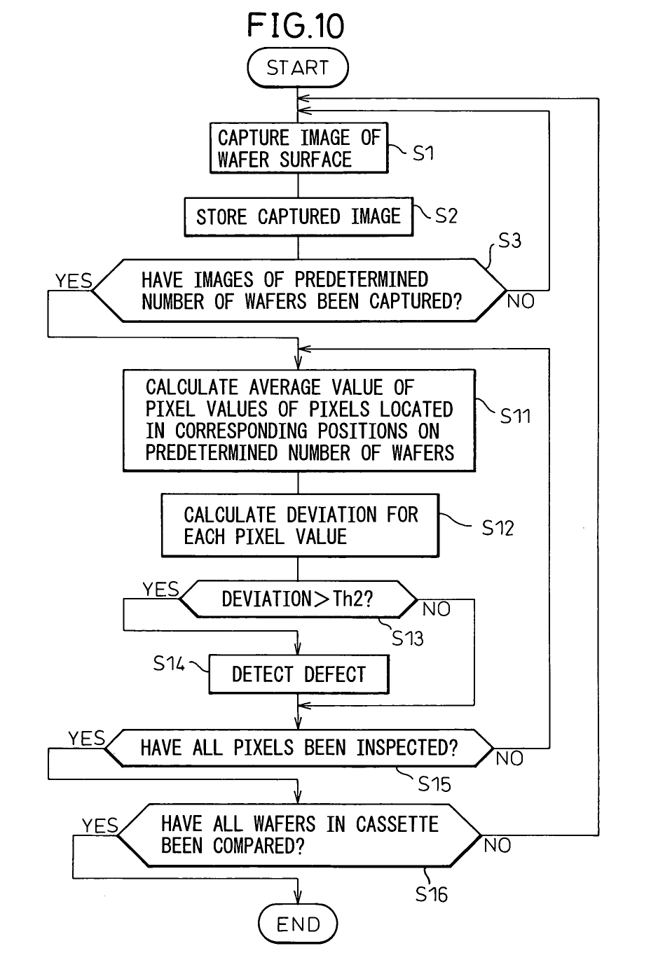

FIG. 10 is a flowchart showing a second example of the appearance inspection method according to the present invention.

First, in steps S1 to S3, as in the corresponding steps in the first example of the appearance inspection method shown in FIG. 7, images are captured of the surfaces of a predetermined number of wafers 23 taken from the plurality of wafers 23 contained in the wafer cassette 61 (or 62), and the captured images thus acquired are stored in the pre-inspection signal storage unit 35.

Next, in step S11, the pixel comparing unit 36 calculates the average value of the pixel values of the pixels located in corresponding positions in the captured images of the predetermined number of wafers 23 stored in the pre-inspection signal storage unit 35. Then, in step S12, for each of the pixels associated with the predetermined number of wafers 23, the pixel comparing unit 36 calculates the deviation from the above average pixel value and supplies the result to the pre-inspection defect detection unit 38.

In step S13, the pre-inspection defect detection unit 38 determines, for each pixel value deviation input thereto, whether the deviation is larger than the detection threshold value Th2 set by the detection threshold value setting unit 37; if the deviation is larger than the detection threshold value Th2, it is determined that the pixel of the wafer 23 exhibiting that deviation is a defect (S14), but if the deviation is not larger than the detection threshold value Th2, it is determined that there is no defect, and the process proceeds to step S15.

The above steps S11 to S14 are repeated for all the pixels contained in the captured image of the predetermined number of wafers 23 (S15). In this way, the entire surfaces of the wafers 23 are inspected for defects.

Then, the above steps S1 to S15 are repeated until the images of all the wafers 23 contained in the cassette 61 (or 62) are captured at least once and compared in step S4 by the pixel comparing unit 36 (S16).

When determining which of the plurality of compared wafers 23 contains the detected defect, the majority decision method previously described with reference to FIGS. 7, 8A, and 8B requires the results of comparisons made between at least three wafers 23. That is, one wafer must be compared with at least two other wafers. Accordingly, the pre-inspection signal storage unit 35 needs to have sufficient capacity to store the captured images of at least two wafers.

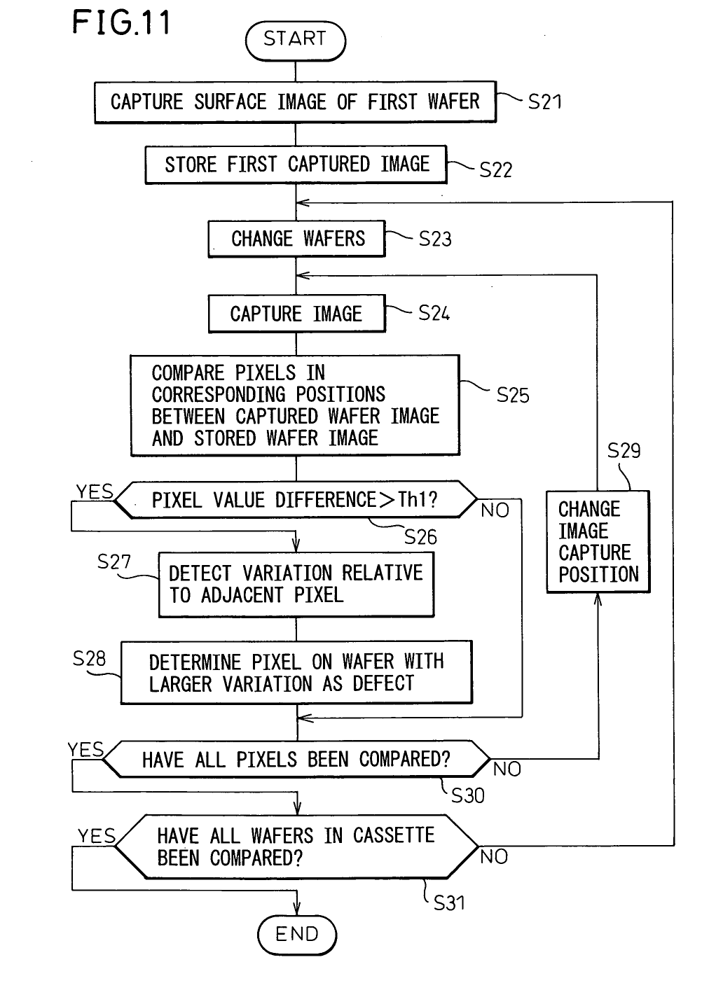

Next, referring to FIG. 11, a description will be given of a method that compares pixels of captured images between only two wafers 23 and yet can determine which of the wafers 23 contains the detected defect when the difference between the pixel values is larger than a predetermined threshold value.

FIG. 11 is a flowchart showing a third example of the appearance inspection method according to the present invention. In this method, when the pixel values of the pixels located in corresponding positions in the captured images of the plurality of wafers 23 differ from each other, pixel value variation between each of the pixels and a pixel adjacent thereto is detected and, between the wafers, the wafer 23 for which the detected variation is the larger is determined as the wafer that contains the defect. For this purpose, the pre-inspection unit 3 includes pixel value variation detection unit 39, as shown FIG. 6, which, for an arbitrary pixel in the captured image, detects the variation of its pixel value relative to an adjacent pixel.

The above method is based on the finding that usually a pixel in any arbitrary position has approximately the same pixel value as adjacent pixels. According to this method, when deciding which of the plurality of wafers 23 compared contains the detected defect, there is no need decide by majority between the wafers 23; accordingly, if the pixel comparison is made between only two wafers 23, it is possible to determine which wafer 23 is responsible for the defect pixel.

The third example of the appearance inspection method according to the present invention will be described below with reference to FIG. 11.

In step S21, the arm mechanism 43 shown in FIG. 4 withdraws the first one of the plurality of wafers 23 from the wafer cassette 61 (or 62) and places it onto the sample holder 32 in the pre-inspection unit 3 shown in FIG. 6. Then, the pre-inspection imaging device 34 acquires a gray level signal by capturing an image of the surface of the wafer 23 placed on the sample holder 32.

Then, in step S22, the captured image thus acquired is stored in the pre-inspection signal storage unit 35.

In step S23, the arm mechanism 43 shown in FIG. 4 replaces the wafer 23 placed on the sample holder 32 with another wafer 23 withdrawn from the wafer cassette 61 (or 62). Then, in step S24, the pre-inspection imaging device 34 acquires a captured image by capturing an image of a prescribed image capture start position on the wafer 23 thus placed.

In step S25, each pixel in the image of the wafer 23 captured in step S24 is input to the pixel comparing unit 36. At the same time, from the captured image of the immediately preceding wafer 23 stored in the pre-inspection signal storage unit 35, the pixel located at the position corresponding to the image capture position captured in step S24 is read out, and input to the pixel comparing unit 36. Then, the pixels taken from the corresponding positions in the captured images of the two wafers are compared with each other, and the difference between their pixel values is supplied to the pre-inspection defect detection unit 38.

In step S26, the pre-inspection defect detection unit 38 determines whether the difference input thereto is larger than the detection threshold value Th1 set by the detection threshold value setting unit 37; if the pixel value difference is larger than the detection threshold value Th1, it is determined that there is a defect, and the process proceeds to step S27. If the pixel value difference is not larger than the detection threshold value Th1, it is determined that there is no defect, and the process proceeds to step S30.

In step 27, for each of the pixels compared between the image of the wafer 23 captured in step S24 and the image of the immediately preceding wafer 23 stored in the pre-inspection signal storage unit 35, the pixel value variation detection unit 39 detects pixel value variation between that pixel and a pixel adjacent thereto, and supplies the value of the variation to the pre-inspection defect detection unit 38.

Then, in step S28, between the wafer 23 whose image was captured in step S24 and the immediately preceding wafer 23 whose captured image is stored in the pre-inspection signal storage unit 35, the pre-inspection defect detection unit 38 determines that the pixel associated with the wafer 23 for which the variation value is the larger, is a defect.

The above steps S24 to S28 are repeated while changing the image capture position in step S29 until the processing is completed for all the regions on the surfaces of the wafers 23 (S30), thus inspecting the entire surfaces of the wafers 23 for defects.

Then, the above steps S23 to S30 are repeated until the images of all the wafers 23 contained in the cassette 61 (or 62) are captured at least once and compared in step S25 by the pixel comparing unit 36 (S31).

The third example of the appearance inspection method according to the present invention has been described above by dealing with the case where two wafers 23 are compared, but it will be appreciated that the method of this example can also be applied to the case where three or more wafers 23 are compared.

According to the present invention, the peripheral area outside the repeating pattern area can be inspected for defects, which has not been possible with the prior art die-to-die comparison or cell-to-cell comparison. This makes it possible to identify the source of particles that can develop from the peripheral area of the substrate, and serves to contribute to the process management.

Furthermore, as there is no need to create an exemplary reference image from a large number of captured images, the peripheral area of the substrate can be inspected for defects in a simple manner.

The present invention can be applied to an appearance inspection apparatus and an appearance inspection method for detecting a defect appearing on a surface of a substrate on which an electrical pattern is formed; in particular, the invention can be applied to an appearance inspection apparatus and an appearance inspection method for detecting a defect on a substrate, such as a liquid crystal display panel or in a semiconductor circuit pattern formed on a substrate such as a semiconductor wafer, during a semiconductor fabrication process.

While the invention has been described with reference to specific embodiments chosen for purpose of illustration, it should be apparent that numerous modifications could be made thereto, by those skilled in the art, without departing from the basic concept and scope of the invention.

What is claimed is:

1. An appearance inspection apparatus for detecting a defect appearing on a surface of a substrate on which a pattern is formed or is to be formed, comprising:
imaging unit which captures an image of said substrate;
pixel comparing unit which compares pixels between images captured of a plurality of said substrates, said pixels being located in corresponding positions in said captured images of said substrates; and
defect detecting unit which detects one or other of the pixels associated with said plurality of substrates as a defect when the pixel associated with one of said substrates differs in pixel value from the pixel associated with the other one of said substrates.

2. An appearance inspection apparatus as claimed in claim 1, wherein
for said plurality of substrates, said pixel comparing unit compares the pixels located in corresponding positions in the captured images of said substrates, and
said defect detecting unit determines which of said substrates contains said defect, by majority rule based on results of said comparison.

3. An appearance inspection apparatus as claimed in claim 1, wherein
for each of the pixel values of the pixels located in corresponding positions in the captured images of said plurality of substrates, said pixel comparing unit obtains a deviation from an average value of said pixel values, and
said defect detecting unit determines that the substrate for which said deviation is larger than a predetermined threshold value is the substrate that contains said defect.

4. An appearance inspection apparatus as claimed in claim 1, further comprising pixel value variation detecting unit which detects pixel value variation between an arbitrary pixel in said captured image and a pixel adjacent thereto, and wherein
when the pixel values of the pixels located in corresponding positions in the captured images of said plurality of substrates differ from each other, said defect detecting unit determines that, between said substrates, the substrate for which the variation detected by said pixel value variation detecting unit between said arbitrary pixel and said adjacent pixel is the larger is the substrate that contains said defect.

5. An appearance inspection apparatus as claimed in claim 1, wherein
a repeating pattern is formed as said pattern on the surface of said substrate, and
said defect detecting unit detects a defect appearing in an area on the surface of said substrate other than an area thereof where said repeating pattern is formed.

6. An appearance inspection apparatus as claimed in claim 5, wherein
for said plurality of substrates, said pixel comparing unit compares the pixels located in corresponding positions in the captured images of said substrates, and
said defect detecting unit determines which of said substrates contains said defect, by majority rule based on results of said comparison.

7. An appearance inspection apparatus as claimed in claim 5, wherein
for each of the pixel values of the pixels located in corresponding positions in the captured images of said plurality of substrates, said pixel comparing unit obtains a deviation from an average value of said pixel values, and
said defect detecting unit determines that the substrate for which said deviation is larger than a predetermined threshold value is the substrate that contains said defect.

8. An appearance inspection apparatus as claimed in claim 5, further comprising a pixel value variation detecting unit which detects pixel value variation between an arbitrary pixel in said captured image and a pixel adjacent thereto, and wherein
when the pixel values of the pixels located in corresponding positions in the captured images of said plurality of substrates differ from each other, said defect detecting unit determines that, between said substrates, the substrate for which the variation detected by said pixel value variation detecting unit between said arbitrary pixel and said adjacent pixel is the larger is the substrate that contains said defect.

9. An appearance inspection apparatus as claimed in any one of claims 1 to 8, wherein said substrate is a semiconductor wafer or a substrate for a liquid crystal device.

10. An appearance inspection method for detecting a defect appearing on a surface of a substrate on which an electrical pattern is formed or is to be formed, comprising:
capturing an image of said substrate;
comparing pixels between images captured of a plurality of said substrates, said pixels being located in corresponding positions in said captured images of said substrates; and
detecting one or the other of the pixels associated with said plurality of substrates as a defect when the pixel associated with one of said substrates differs in pixel value from the pixel associated with the other one of said substrates.

11. An appearance inspection method as claimed in claim 10, wherein
said comparison between said pixels located in corresponding positions in the captured images of said substrates is made for said plurality of substrates, and
a determination as to which of said substrates contains said defect is made by majority rule based on results of said comparison.

12. An appearance inspection method as claimed in claim 10, wherein
for each of the pixel values of the pixels located in corresponding positions in the captured images of said plurality of substrates, a deviation from an average value of said pixel values is obtained, and
the substrate for which said deviation is larger than a predetermined threshold value is determined as the substrate that contains said defect.

13. An appearance inspection method as claimed in claim 10, wherein when the pixel values of the pixels located in corresponding positions in the captured images of said plurality of substrates differ from each other, pixel value variation between each of said pixels and a pixel adjacent thereto is detected and, between said substrates, the substrate for which the detected variation is the larger is determined as the substrate that contains said defect.

14. An appearance inspection method as claimed in claim 10, wherein
a repeating pattern is formed as said pattern on the surface of said substrate, and
a defect appearing in an area on the surface of said substrate, other than an area thereof where said repeating pattern is formed, is detected.

15. An appearance inspection method as claimed in claim 14, wherein
said comparison between said pixels located in corresponding positions in the captured images of said substrates are made for said plurality of substrates, and
a determination as to which of said substrates contains said defect is made by majority rule based on results of said comparison.

16. An appearance inspection method as claimed in claim 14, wherein
for each of the pixel values of the pixels located in corresponding positions in the captured images of said plurality of substrates, a deviation from an average value of said pixel values is obtained, and
the substrate for which said deviation is larger than a predetermined threshold value is determined as the substrate that contains said defect.

17. An appearance inspection method as claimed in claim 14, wherein when the pixel values of the pixels located in corresponding positions in the captured images of said plurality of substrates differ from each other, pixel value variation between each of said pixels and a pixel adjacent thereto is detected and, between said substrates, the substrate for which the detected variation is the larger is determined as the substrate that contains said defect.

18. An appearance inspection method as claimed in any one of claims 10 to 17, wherein said substrate is a semiconductor wafer or a substrate for a liquid crystal device.
